(19) United States
(12) Patent Application Publication
(10) Pub. No.: US 2006/0177799 A9
(43) Pub. Date: Aug. 10, 2006

(54) Methods and devices for treating non-stuttering speech-language disorders using delayed auditory feedback

(76) Inventors: Andrew M. Stuart, Winterville, NC (US); Joseph S. Kalinowski, Greenville, NC (US); Michael P. Rastatter, Greenville, NC (US)

Correspondence Address: MYERS BIGEL SIBLEY & SAJOVEC, PO BOX 37428, RALEIGH, NC, 27627, US

(21) Appl. No.: 10/424,088

(22) Filed: Apr. 25, 2003

Related U.S. Application Data
(60) Provisional application No. 60/375,937, filed on Apr. 26, 2002.

(51) Int. Cl. G09B 21/00

(52) U.S. Cl. 434/112; 434/185; 704/271

(57) ABSTRACT

Methods, devices and systems treat non-stuttering speech and/or language related disorders by administering a delayed auditory feedback signal having a delay of under about 200 ms via a portable device. The DAF treatment may be delivered on a chronic basis. For certain disorders, such as Parkinson's disease, the delay is set to be under about 100 ms, and may be set to be even shorter such as about 50 ms or less. Certain methods treat cluttering (an abnormally fast speech rate) by exposing the individual to a DAF signal having a sufficient delay that automatically causes the individual to slow his or her speech rate.

### RELATED APPLICATIONS

This application claims priority to U.S. Provisional Application Ser. No. 60/375,937 filed Apr. 26, 2002, the contents of which are hereby incorporated by reference as if recited in full herein.

### FIELD OF THE INVENTION

The present invention relates generally to treatments for non-stuttering speech and/or language disorders.

### BACKGROUND OF THE INVENTION

Conventionally, delayed auditory feedback (“DAF”) has been successfully used for treating individuals who stutter. See e.g., Bloodstein, O., A Handbook on Stuttering, pp. 327-357, 5th ed., (National Easter Seal Society, Chicago, 1995). In contrast, numerous experiments with normal speakers have shown that DAF can produce disruptive effects on the speech. Such effects include speech errors (e.g., repetition of phonemes, syllables, or words), changes in speech rate/reading duration, prolonged voicing, increased vocal intensity, and modifications in aerodynamics (Black, 1951; Fukawa, Yoshioka, Ozawa, & Yoshida, 1988; Howell, 1990; Langova, Moravek, Novak, & Petrik, & 1970; Lee, 1950, 1951; Mackay, 1968; Siegel, Schork, Pick, & Garber, 1982; Stager, Denman, & Ludlow, 1997; Stager & Ludlow, 1993). Several theorists (Black, 1951; Cherry & Sayers, 1956; Van Riper, 1982; Yates, 1963) have proposed that the speech disruptions of normal speakers under DAF are an analog of stuttering since these disruptions are similar to stuttering. Put simply, normal speakers can be made to “artificially stutter” under DAF.

In the past, investigators have typically utilized “long” delays ranging 100 to 300 ms to evaluate the effects of DAF on normal speakers. It is believed that there is only one study investigating the effect of different rates of speaking (e.g., normal versus a fast rate) and DAF on normal speakers. Zanini, Clarici, Fabbro, and Bava (1999), reported that participants speaking at a normal rate while receiving 200 ms DAF produced significantly more speech errors that those receiving no DAF. With an increased speaking rate, the total number of speech errors increased for those receiving no DAF but remained approximately the same for those receiving DAF. There was no significant difference in speech errors at an increased speaking rate between those receiving DAF and those not. There is no evidence of the effect of speech rate and DAF at shorter delays.

In past studies, there appears to be an absence of an operational definition of “errors in speech production” or “dysfluency” that makes interpretation of earlier work particularly problematic. Specifically, definitions for dysfluency such as “misarticluations” (Ham, Fucci, Cantrell, & Harris, 1984), “hesitations” (Stephen & Haggard, 1980), or “slurred syllables” (Zalosh & Salzman, 1965) are not consistent with the standard definition of dysfluent behaviors of individuals who stutter (i.e., part word repetitions, prolongations, and postural fixations).

Nonetheless, there are individuals with non-stuttering speech and/or language related disorders that desire treatment so as to promote communication skills, increase fluency, and/or make speech or language more “normal”. In the past, DAF has been proposed to treat certain non-stuttering disorders, such as Parkinson's disease. See, e.g., Downie et al., Speech disorder in parkinsonism—usefulness of delayed auditory feedback in selected cases, Br. J. Disord Commun, 16(2), pp. 135-139 (September 1981). However, the delays proposed by these studies or treatments have been relatively long, which may actually promote disfluency in certain non-stuttering individuals. Further, the conventional proposed devices used to deliver such treatment may be undesirably cumbersome and/or useable only in a clinical environment. Unfortunately, each of these disadvantages may be potentially limiting to the desired therapeutic benefit or outcome.

Despite the foregoing, there remains a need for methods and related devices that can provide remedial treatments for increasing communication skills for individuals having non-stuttering pathologies.

### SUMMARY OF THE INVENTION

The present invention is directed to methods, systems, and devices for treating non-stuttering speech and/or language related disorders using delayed auditory feedback (“DAF”).

The devices and methods can be configured to provide the DAF input via a miniaturized minimally obtrusive device and may be able to be worn so as to promote on-demand or chronic use or therapy (such as daily) and the like. The minimally obtrusive portable device may be configured as a compact, self-contained and relatively economical device which is small enough to be insertable into or adjacent an ear, and, hence, supported by the ear without requiring remote wires or cabling when in operative position on/in the user. The device may be configured to be a wireless device with a small ear mountable housing and a pocket controller that can be sized and/or shaped for use with one of a behind-the-ear (“BTE”), an in-the-ear (“ITE”), in-the-canal (“ITC”), or completely-in-the-canal (“CIC”) device.

In certain embodiments, the delay provided by the DAF treatment methods, systems, and devices can be relatively short, such as under about 100 ms. In certain particular embodiments, the delay can be under about 50 ms.

In particular embodiments, the device can reduce speech rate in individuals having a cluttering speech disorder thereby providing a more natural or normal speech rate.

In particular embodiments, the methods and devices can be configured to treat children with learning disabilities, including reading disabilities, in a normal educational environment such as at a school or home (outside a clinic).

The methods and devices may increase communication skills in one or more of preschool-aged children, primary school-aged children, adolescents, teenagers, adults, and/or the elderly (i.e., senior citizens).

In particular embodiments, the methods and devices may be used to treat individuals having non-stuttering pathologies or disorders that impair communication skills, such as schizophrenia, autism, learning disorders such as attention deficit disorders (“ADD”), neurological impairment from brain impairments that may occur from strokes, trauma, injury, or a progressive disease such as Parkinson's disease, and the like.

In certain embodiments, the device is configured to allow treatment by ongoing substantially “on-demand” use while in position on the subject separate from and/or in addition to clinically provided episodic treatments during desired periods of service.

Certain aspects of the invention are directed toward methods for treating non-stuttering pathologies of subjects having impaired or decreased communication skills. The methods include administering a DAF signal to a subject having a non-stuttering pathology while the subject is speaking or talking to thereby improve the subject's communication skills.

Certain embodiments of the invention are directed at methods for treating a cluttering speech disorder in a subject. The cluttering speech disorder is a disorder wherein the natural speech rate of the subject is abnormally fast relative to the general population. The method includes administering a delayed auditory feedback signal to the subject having a cluttering speech and/or language disorder, wherein the delayed auditory feedback signal has an associated delay that is less than 200 ms.

Other embodiments are directed to methods for treating non-stuttering speech and/or language disorders in a subject in need of such treatment by administering a delayed auditory feedback signal with a delay of less than about 100 ms to the subject.

In particular embodiments, the step of administering is carried out proximate in time to when the subject is performing at least one task of the group consisting of: communicating with another; writing; listening; speaking and/or reading.

The treatment can include: (a) positioning a device which may be self contained or operate in wireless mode for receiving auditory signals associated with an individual's speech in close proximity to the ear of an individual, the device being adapted to be in communication with the ear canal of said individual; (b) receiving an audio signal associated with the individual's speech; (c) generating a delayed auditory signal having an associated delay of less than 100 ms responsive to the received audio signal; and (d) transmitting the delayed auditory signal to the ear canal of the individual.

Other embodiments are directed to devices for treating a cluttering speech disorder, wherein the natural speech rate of a subject is abnormally fast relative to the general population, comprising: (a) means for generating a delayed auditory feedback signal wherein the delayed auditory feedback signal has an associated delay that is less than 200 ms; and (b) means for transmitting the delayed auditory signal to a subject having a cluttering speech and/or language disorder.

Still other embodiments are directed to devices for treating a non-stuttering speech disorder, including: (a) means for generating a delayed auditory feedback signal wherein the delayed auditory feedback signal has an associated delay that is less than 100 ms; and (b) means for transmitting the delayed auditory signal to a subject having a speech and/or language disorder.

Another embodiment is directed toward a portable device for treating non-stutterers having speech and/or language disorders. The device includes: (a) an ear-supported housing having opposing distal and proximal surfaces, wherein at least the proximal surface is configured for positioning in the ear canal of a user; (b) a signal processor; and (c) a power source operatively associated with said signal processor for supplying power thereto. The signal processor includes: (i) a receiver, the receiver generating an input signal responsive to an auditory signal associated with the user's speech; (ii) delayed auditory feedback circuitry operatively associated with the receiver for generating a delayed auditory signal having a delay of about 100 ms or less; and (iii) a transmitter operatively associated with the delayed auditory feedback circuitry for transmitting the delayed auditory signal to the user. The signal processor is configured to reside in the ear-supported housing and/or in a wirelessly operated portable housing that is configured to be worn by the user that wirelessly communicates with the ear-supported housing to cooperate with the ear-supported housing to deliver the delayed auditory feedback to the user.

Embodiments of the above may be implemented as methods, devices, systems and/or computer programs.

### BRIEF DESCRIPTION OF THE DRAWINGS

FIG. 1 is a side perspective view of a device configured for in the ear (ITE) use for treating non-stuttering speech and/or language related disorders or pathologies according to embodiments of the present invention.

FIG. 2 is a cutaway sectional view of the device of FIG. 1, illustrating its position in the ear canal according to embodiments of the present invention.

FIG. 3 is a side perspective view of a behind the ear device (“BTE”) for treating non-stuttering speech and/or language related disorders or pathologies according to alternate embodiments of the present invention.

FIG. 3B is a section view of the device of FIG. 3A, illustrating the device in position, according to embodiments of the present invention.

FIGS. 4A-4E are side views of examples of different types of miniaturized configurations that can be used to provide the DAF treatment for non-stuttering speech and/or language related disorders according to embodiments of the present invention.

FIG. 5 is a schematic diagram of an exemplary signal processing circuit according to embodiments of the present invention.

FIG. 6A is a schematic illustration of an example of digital signal processor (DSP) architecture that can be configured to administer a DAF treatment to an individual having a non-stuttering speech and/or language disorder according to embodiments of the present invention.

FIG. 6B is a schematic illustration of an auditory feedback system for a device comprising a miniaturized compact ITE, ITC, or CIC component according to embodiments of the present invention.

FIG. 7A is a schematic diagram of a non-stuttering user having an abnormally fast normal speech rate that is treated with DAF according to embodiments of the present invention.

FIG. 7B is a flow diagram of operations that can be carried out to deliver a DAF input to a user having a “cluttering” speech/language disorder according to embodiments of the present invention.

FIG. 8 is a graph of the number of disfluencies versus the amount of delay in the delayed auditory feedback for normal speakers. The graph illustrates two speech rates, normal and fast.

FIG. 9 is a graph of the number of syllables generated by a normal speaker at the two different speech rates shown in FIG. 8 versus the amount of delay provided by the delayed auditory feedback.

FIG. 10 is top view of a programming interface device to provide communication between a therapeutic DAF device and a computer or processor according to embodiments of the present invention.

FIG. 11 is an enlarged top view of the treatment device-end portion of an interface cable configured to connect the device to a programmable interface.

FIG. 12 is an enlarged top view of the interface cable shown in FIGS. 10 and 11 illustrating the connection to two exemplary devices.

FIG. 13 is a top perspective view of a plurality of different sized compact devices, each of the devices having computer interface access ports according to embodiments of the present invention.

FIG. 14 is a screen view of a programmable input program providing a clinician selectable program parameters according to embodiments of the present invention.

### DETAILED DESCRIPTION OF EMBODIMENTS OF THE INVENTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the drawings, certain features, components, layers and/or regions may be exaggerated for clarity. Like numbers refer to like elements throughout the description of the drawings. It will be understood that when an element such as a layer, region or substrate is referred to as being “on” another element, it can be directly on the other element or intervening elements may also be present. In contrast, when an element is referred to as being “directly on” another element, there are no intervening elements present.

In the description of the present invention that follows, certain terms are employed to refer to the positional relationship of certain structures relative to other structures. As used herein, the term “proximal” and derivatives thereof refer to a location in the direction of the ear canal toward the center of the skull while the term “distal” and derivatives thereof refer to a location in the direction away from the ear canal.

Generally described, the present invention is directed to methods, systems, and devices that treat subjects having non-stuttering pathologies to facilitate and/or improve speech and/or language disorders. Certain embodiments are directed to facilitating or improving communication skills associated with speech and/or language disorders. The term “communication skills” includes, but is not limited to, writing, speech, and reading. The term “writing” is used broadly to designate assembling symbols, letters and/or words to express a thought, answer, question, or opinion and/or to generate an original or copy of a work of authorship, in a communication medium (a tangible medium of expression) whether by scribing, in print or cursive, onto a desired medium such as paper, or by writing via electronic input using a keyboard, mouse, touch screen, or voice recognition software. The terms “reading” and “reading ability” mean reading comprehension, cognizance, and/or speed.

The terms “talking” and “speaking” are used interchangeably herein and includes verbal expressions of voice, whether talking, speaking, whispering, singing, yelling, and whether to others or oneself. The pathology may present with a reading impairment. In particular embodiments, the DAF signal may be delivered while the subject is reading aloud in a substantially normal speaking voice at a normal speed and level (volume). In other embodiments, the DAF signal may be delivered while the subject is reading aloud with a speaking voice that is reduced from a normal volume (such as a whisper or a slightly audible level). In certain embodiments, the verbal output may be sufficiently loud so that the auditory signal from the speaker's voice or speech can be detected by the device (which may be miniaturized as will be discussed below), whether the verbal output of the subject is associated with general talking, speaking, or communicating, or such talking or speaking is in relationship to spelling, reading (intermittent or choral), transforming the spoken letters into words, and/or transforming connected thoughts, words or sentences into coherent expressions or into a written work, such as in forming words or sentences for written works of authorship.

Examples of non-stuttering speech and/or language pathologies that may be suitable for treatment according to operations proposed by the present invention include, but are not limited to, learning disabilities (“LD”), including reading disabilities such as dyslexia, attention deficit disorders (“ADD”), attention deficit hyperactivity disorders (“ADHD”) and the like, asphasis, dyspraxia, dysarthria, dysphasia, autism, schizophrenia, progressive degenerative neurological diseases such as Parkinson's disease and/or Alzheimer's disease, and/or brain injuries or impairments associated with strokes, cardiac infarctions, trauma, and the like. In certain embodiments, children having developmental praxia, auditory processing disorders, developmental language disorders or specific language impairments, or phonological processing disorders may be suitable for treatment with methods and/or devices contemplated within the scope of the present invention.

The treatment may be particularly suitable for individuals having diagnosed learning disabilities that include reading disabilities or impairments. A learning disability may be assessed by well-known testing means that establishes that an individual is performing below his/her expected level for age or I.Q. For example, a reading disability may be diagnosed by standardized tests that establish that an individual is below an age level reading expectation, such as, but not limited to, the Stanford Diagnostic Reading Test. See Carlson et al., Stanford Diagnostic Reading Test (NY, Harcourt Brace Javanovich, 1976). A reading disability may also be indicated by comparison to the average ability of individuals of similar age. In other embodiments, a relative decline in a subject's own reading ability may be used to establish the presence of a reading disability. The subject to be treated may be a child having a non-stuttering learning disability with reduced reading ability relative to age expectation based on a standardized diagnostic test and the child may be of pre-school age and/or primary school age (grades K-8). In other embodiments, the individual can be a teenager or high school student, an adult (which may be a university or post-high school institution student), or a middle age adult (ages 30-55), or an elderly person such as a senior citizen (greater than age 55, and typically greater than about 62). As above, the individual may have a diagnosed reading disability established by a diagnostic test, the individual may have reduced reading ability relative to the average ability of individuals of similar age, or the individual may have a recognized onset of a decrease in functionality over their own prior ability or performance.

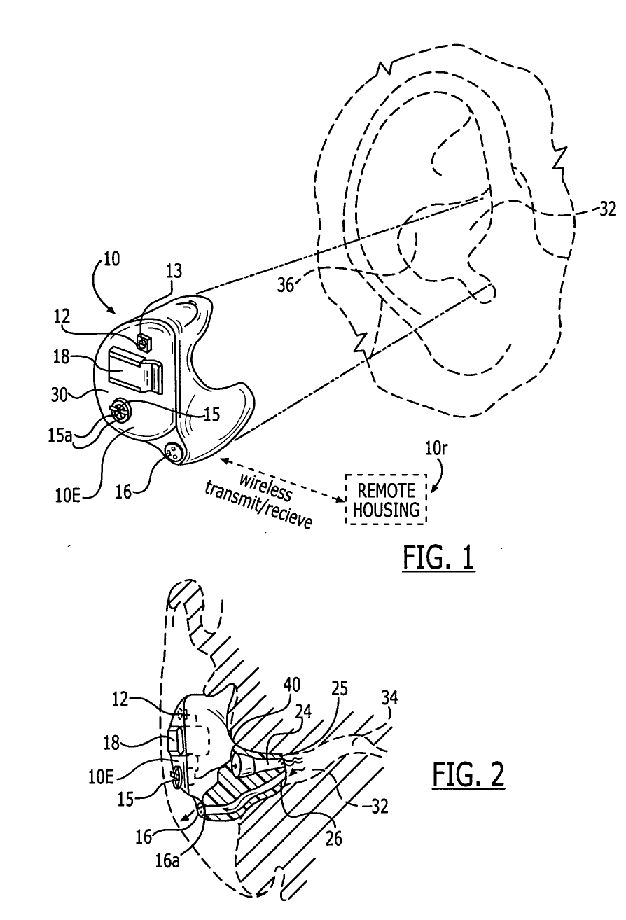

In certain embodiments as shown in FIGS. 1-4, the DAF treatment may be provided by a minimally obtrusive portable device 10. Optionally, as shown by the features in broken line in FIG. 1, the device 10 can include a wireless remote component 10R that cooperates with the ear-supported component 10E to provide the desired therapeutic input. Thus, as is well known to those of skill in the art, the wireless system configuration may include the ear mounted component 10E, a processor which may be held in the remote housing 10H and a wireless transmitter that allows the processor to communicate with the ear mounted component 10E. Examples of wireless headsets include the Jabra® FreeSpeak Wireless System and other hands-free models that are available from Jabra Corporation located in San Diego, Calif. Examples of patents associated with hands-free communication devices that employ ear buds, ear hooks, and the like include U.S. Pat. Nos. D469,08 1, 5,812,659 and 5,659,156, the contents of which are hereby incorporated by reference as if recited in full herein.

Alternatively, the device 10 can be self-contained and supported by the ear(s)of the user. In both the wireless and self-contained embodiments, the device 10 can be configured as a portable, compact device with the ear-mounted component being a small or miniaturized configuration. Thus, in the description of certain embodiments that follows, the device 10 is described as having certain operating components that administer the DAF. These components may reside entirely in the in the ear-mounted device 10E or certain components may be housed in the wirelessly operated remote device 10R where such a remote device is used. For example, the controller and/or certain delayed auditory feedback signal processor circuitry and the like can be held in the remote housing 10R.

In other embodiments, wired versions of portable DAF feedback systems may be used, typically with a light-weight head mounted or ear-mounted component(s) (not shown).

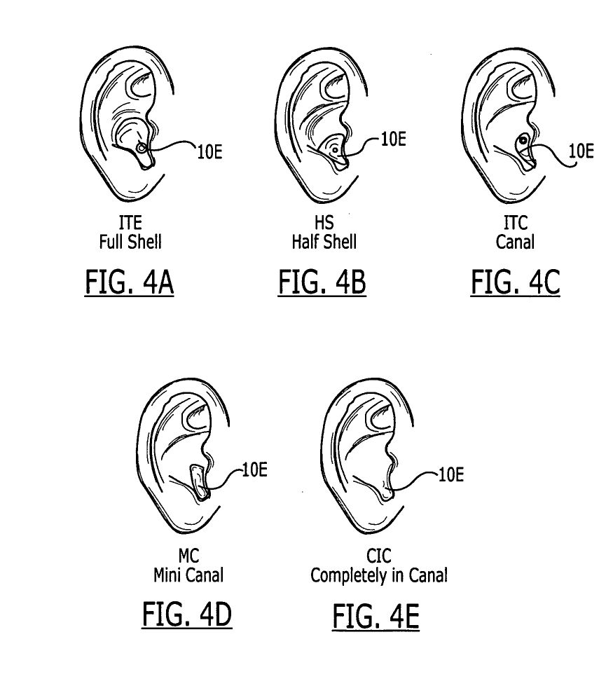

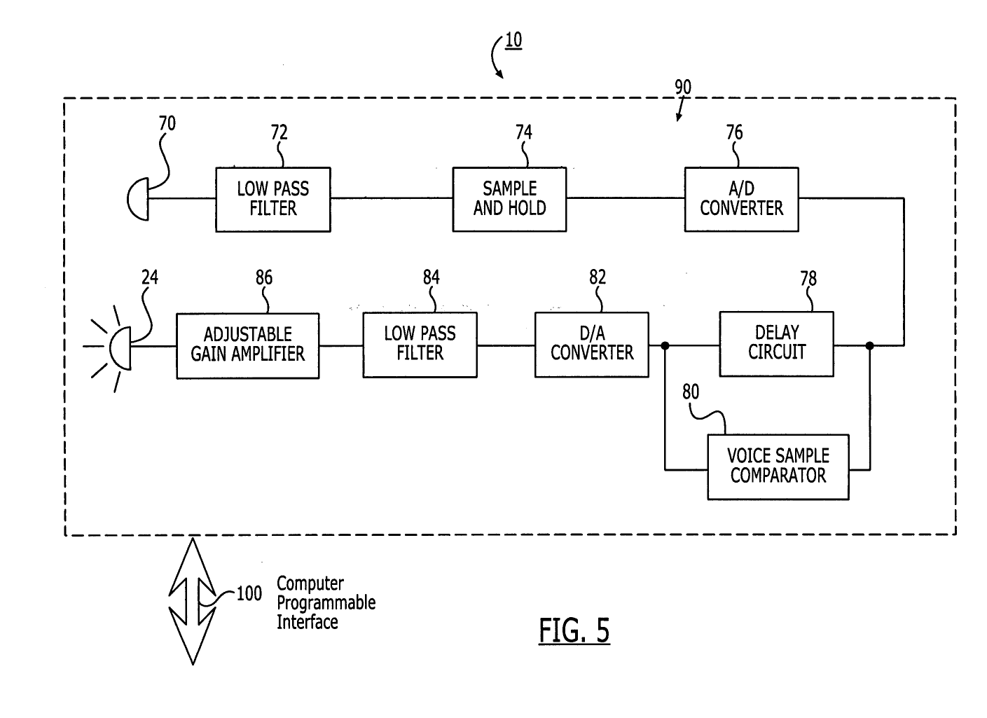

FIGS. 1, 2, and 4A illustrate that the ear mounted device 10E can be configured as an ITE device. FIGS. 3A and 3B illustrate that the ear mounted device 10E can be configured as a BTE device. FIGS. 4B-4E illustrate various suitable configurations. FIG. 4C illustrates an ITC version, and FIG. 4B illustrates a “half-shell” (“HS”) version of an ITC configuration. FIG. 4D illustrates a mini-canal version (“MC”) and FIG. 4E illustrates a completely-in-the-canal (“CIC”). As such, the CIC configuration can be described as the smallest of the devices and is largely concealed in the ear canal.

As will be discussed in more detail below, the non-stuttering speech and/or language disorder therapeutic device 10 includes a signal processor including a receiver, a delayed auditory feedback circuit, and a transmitter. In certain particular embodiments, selected components, such as a receiver or transducer, may be located away from the ear canal, although still typically within close proximity thereto. Generally described, in operation, the portable device receives input sound signals from a patient at a position in close proximity to the ear (such as via a microphone in or adjacent the ear), processes the signal, amplifies the signal, and delivers the processed signal into the ear canal of the user.

Referring now to the drawings, one embodiment of a device is shown in FIG. 1. As illustrated, the device 10 can be a single integrated ear-supported unit 10E that is self-contained and does not require wires. Optionally, the device 10 can include both the ear-supported unit 10E and a remote portable unit 10R that is in wireless communication with the ear-mounted unit 10E. Thus, the device 10 includes an ear-supported unit 10E with a housing 30 configured to be received into the ear canal 32 close to the eardrum 34. Although shown throughout as a right ear model, a mirror image of the figure is applicable to the opposing, left ear. Similarly, although shown as a single unit in one ear, in certain embodiments, the user may employ two discrete ear-mounted devices 10E, one for each ear (not shown). The housing 30 can include a proximal portion which is insertable a predetermined distance into the ear canal 32 and is sized and configured to provide a comfortable, snug fit therein. The material of the housing 30 can be a hard or semi-flexible elastomeric material, such as a polymer, copolymer, derivatives or blends and mixtures thereof.

As shown in FIG. 1, the device 10 includes a receiver 12, a receiver inlet 13, an accessory access door 18, a volume control 15, and a small pressure equalization vent 16. The receiver 12, such as a transducer or microphone can be disposed in a portion of the housing 30 that is positioned near the entrance to the ear canal 36 so as to receive sound waves with a minimum of blockage. More typically, the receiver 12 is disposed on or adjacent a distal exterior surface of the housing and the housing 30 optionally includes perforations 13 to allow uninhibited penetration of the auditory sound waves into the receiver or microphone.

As shown, the device 10 also includes an accessory access panel, shown in FIG. 1 as a door member 18. The door member 18 can allow relatively easy access to the internal cavity of the device so as to enable the interchange of batteries, or to repair electronics, and the like. Further, this door member 18 can also act as an “on” and “off” switch. For example, the device can be turned on and off by opening and closing the door 18. The device can also include a volume control, which is also disposed to be accessible by a patient. As shown the device 10E may include raised gripping projectiles 15a for easier adjustment.

The proximal side of the device 10E can hold the transmitter or speaker 24. The housing 30 can be configured to generally fill the concha of the ear 40 to prevent or block undelayed signals from reaching the eardrum. As shown in FIG. 1, the proximal side of the housing 30 can include at least two apertures 25, 26. A first aperture is a vent opening 26 in fluid communication with the pressure vent 16 on the opposing side of the housing 30. As such the vent openings 16, 26 can be employed to equalize ear canal and ambient air pressure. The distal vent opening 16 can also be configured with additional pressure adjustment means to allow manipulation of the vent opening 16 to a larger size. For example, a removable insert 16a having a smaller external aperture can be sized and configured to be matably inserted into a larger aperture in the vent. Thus, removal of the plug results in an “adjustable” larger pressure vent opening 16.

A second aperture 25 can be disposed to be in and face into the ear canal on the proximal side of the device. This aperture 25 is a sound bore which can deliver the processed signal to the inner ear canal. The aperture 25 may be free of intermediate covering(s), permitting free, substantially unimpeded delivery of the processed signal to the inner ear. Alternatively, a thin membrane or baffle covering (not shown) may be employed over the sound bore 25 to protect the electronics from unnecessary exposure to biological contaminants.

If needed, the housing 30 may contain a semi-flexible extension over the external wall of the ear (not shown) to further affix the housing 30 to the ear, or to provide additional structure and support, or to hold components associated with the device, such as power supply batteries. The electronic operational circuitry may be powered by one or more internally held power sources such as a miniaturized battery of suitable voltage.

An alternative embodiment of the device 10E is the BTE device shown in FIGS. 3A and 3B. As illustrated, the device 10E includes a standard hearing aid shell or housing 50, an ear hook 55, and an ear mold 65. The ear mold 65 is flexibly connected to the ear hook by mold tubing 60. The mold tubing 60 is sized to receive one end of the ear hook 58 ear hook 55 can be formed of a stiffer material than the tubing 60. Accordingly, one end of the ear hook 58 is inserted into the end of the mold tubing 60 to attach the components together. The opposing end 54 of the ear hook 55 is attached to the housing 50. The ear hook end 54 can be threadably engaged to a superior or top portion of the housing 50.

As shown, the ear mold 65 is adapted for the right ear but can easily be configured for the left ear. The ear mold 65 is configured and sized to fit securely against and extend partially into the ear to structurally secure the device to the ear.

The tubing proximal end 60a extends a major distance into the ear mold 65, and more typically extends to be slightly recessed or substantially flush with the proximal side of the ear mold 65. The tubing 60 can direct the signal and minimize the degradation of the transmitted signal along the signal path in the ear mold.

Still referring to FIGS. 3A and 3B, the proximal side of the ear mold 65 can include a sound bore 66 in communication with the tubing 60. In operation, the signal is processed in the housing 50 and is transmitted through the ear hook 54 and tubing 60 into the ear mold 65 and is delivered to the ear canal through a sound bore 66.

An aperture or opening can be formed in the housing 50 to receive the auditory signal generated by the patient's speech. As shown in FIG. 3A, the opening is in communication with an aperture or opening in a receiver such as a microphone 53 positioned on the housing. The receiver or microphone 53 can be positioned in an anterior-superior location relative to the wearer and extend out of the top of the housing 50 so as to freely intercept and receive the signals.

Corrosion-resistant materials, such as a gold collar or suitable metallic plating and/or biocompatible coating, may be included to surround the exposed component in order to protect it from environmental contaminants. The microphone opening 53a can be configured so as to be free of obstructions in order to allow the signal to enter unimpeded or freely therein.

Additionally, the housing 50 can employ various other externally accessible controls (not shown). For example, the anterior portion of the housing can be configured to include a volume control, an on-off switch, and a battery door 18. The door 18 can also provide access to an internal tone control and various output controls.

It is noted that throughout the description, the devices may employ, typically in lieu of a volume control 15, automated compression circuitry such as a wide dynamic range compression (“WDRC”) circuitry. In operation, the circuitry can automatically sample incoming signals and adjust the gain of the signal to lesser and greater degrees depending on the strength of the incoming signal.

The receiver 12, such as a transducer or microphone, can be disposed in a portion of the housing that is positioned near the entrance to the ear canal 36 so as to receive sound waves with a minimum of blockage. More typically, the receiver 12 is disposed on or adjacent a distal exterior surface of the housing of the ear-mounted device 10E and the housing optionally includes perforations 13 to allow substantially uninhibited penetration of the auditory sound waves into the receiver or microphone.

The door 18 can also provide access to an internal tone control and various output controls. Optionally, the BTE device can include an external port (not shown) that engages with an external peripheral device such as a pack for carrying a battery, where long use or increased powering periods are contemplated, or for recharging the internal power source. In addition, the device 10 may be configured to allow interrogation or programming via an external source and may include cabling and adaptor plug-in ports to allow same. For example, as will be discussed further below, the device 10 can be releasably attachable to an externally positioned signal processing circuitry for periodic assessment of operation or linkup to an external evaluation source or clinician.

The external pack, when used, may be connected to the housing (not shown) and configured to be light weight and portable, and preferably supportably attached to a user, via clothing, accessories, and the like, or stationary, depending on the application and desired operation.

In addition, as noted above, the device 10 may include a remote wireless “pocket” housing that holds certain of the circuitry and a wireless transmitter so as to wirelessly communicate with the BTE device 10E.

In position, with the ear mold 65 in place, the BTE device 10E is disposed with the ear hook 55 resting on the anterior aspect of the helix of the auricle with the body of the housing situated medial to the auricle adjacent to its attachment to the skull. Typically, the housing 50 is configured to follow the curve of the ear, i.e., is a generally elongated convex. The housing 50 size can vary, but is preferably sized from about 1 inch to 2.5 inches in length, measured from the highest point to the lowest point on the housing. The ear hook 55 is generally sized to be about 0.75 to about 1 inch for adults, and about 0.35 to about 0.5 inches for children; the length is measured with the hook in the radially bent or “hook” configuration.

In certain embodiments, the receiver 53, i.e., the microphone or transducer is positioned within a distance of about 1 cm to 7 cm from the external acoustic meatus of the ear. It is preferable that the transducer be positioned within 4 cm of the external acoustic meatus of the ear, and more preferable that the transducer be positioned within about 2.5 cm.

In particular embodiments, the device 10 can include an ITE (full shell, half shell or ITC) device 10E positioned entirely within the concha of the ear and the ear canal. In other embodiments, the device 10 can be configured as a BTE device, as noted above, that is partially affixed over and around the outer wall of the ear so as to minimize the protrusion of the device beyond the normal extension of the helix of the ear. Still other embodiments provide the device 10E as a MC or CIC device FIGS. 4D, 4E, respectively.

Hearing aids with circuitry to enhance hearing with a housing small enough to either fit within the ear canal or be entirely sustained by the ear are well known. For example, U.S. Pat. No. 5,133,016 to Clark discloses a hearing aid with a housing containing a microphone, an amplification circuit, a speaker, and a power supply, that fits within the ear and ear canal. Likewise, U.S. Pat. No. 4,727,582 to de Vries et al. discloses a hearing aid with a housing having a microphone, an amplification circuit, a speaker, and a power supply, that is partially contained in the ear and the ear canal, and behind the ear. Each of the above-named patents is hereby incorporated by reference in their entireties as if fully recited herein. For additional description of a compact device used to ameliorate stuttering, see U.S. Patent No. 5,961,443, the contents of which are hereby incorporated by reference as if recited in full herein.

In certain embodiments, the DAF auditory delay is provided by digital signal processing technology that provides programmably selectable operating parameters that can be customized to the needs of a user and adjusted at desired intervals such as monthly, quarterly, annually, and the like, typically by a clinician or physician evaluating the individual. The programmably selectable and/or adjustable operating parameters can include a customized “fitting” program to define user specific parameters such as volume, signal delay selections, octave shift, linear gain (such as about four 5-dB step size increments), frequency and the like. The delayed auditory feedback (“DAF”) can be programmed into the device (typically with an adjustably selectable delay time of between about 0-128 ms) and the programmable interface and the internal operating circuitry and/or the signal processor, which may be one or more of a microprocessor or nanoprocessor, can be configured to allow adjustable and/or selectable operational configurations of the device to operate in the desired feedback mode or modes.

Further, the device 10 can be configured to provide either or both FAF and DAF altered auditory feedbacks and the programmable interface and the internal operating circuitry and/or microprocessor or nanoprocessor can be configured to selectable configure the device to operate in the desired feedback mode or modes. For additional description of a compact device used to ameliorate stuttering, see Stuart et al., Self-Contained In-The Ear Device to Deliver Altered Auditory Feedback: Applications for Stuttering, Annals of Biomedical Engr. Vol.31, pp.233-237 (2003), the contents of which are hereby incorporated by reference as if recited in full herein.

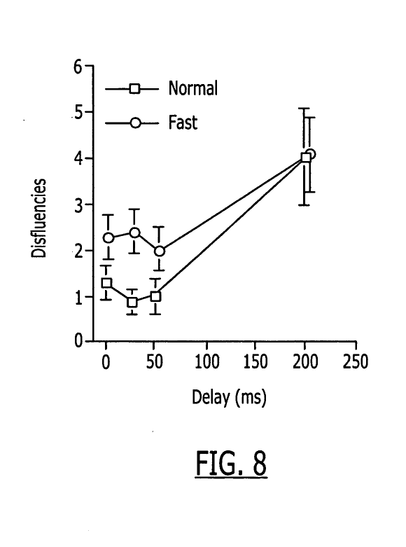

In any event, irrespective of the configuration of the DAF implementing operational circuitry, the DAF delay can be set to below 200 ms. That is, as FIG. 8 illustrates, disfluency can increase in non-stuttering speakers when the selected DAF induced delay is at 200 ms. Thus, certain embodiments set the DAF signal delay to less than or equal to about 100 ms. In more particular embodiments, the delay can be set to less than or equal to about 50 ms. For example, between about 1-50 ms, and typically between about 10-50 ms.

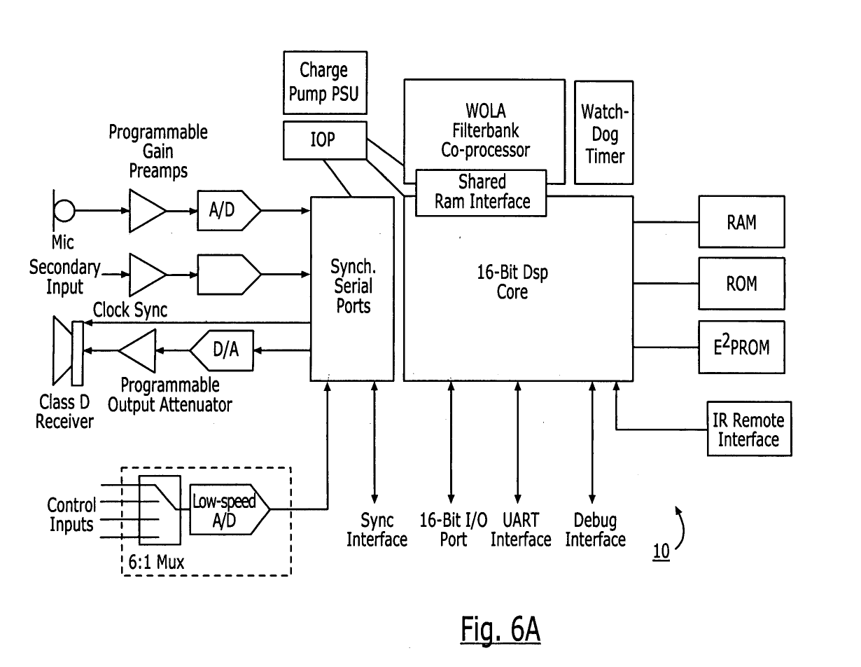

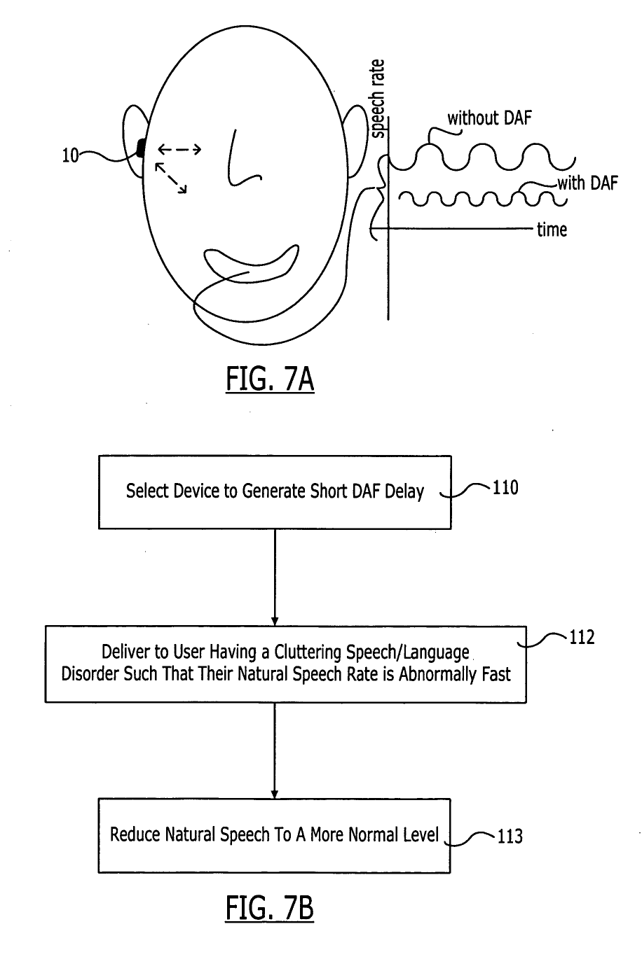

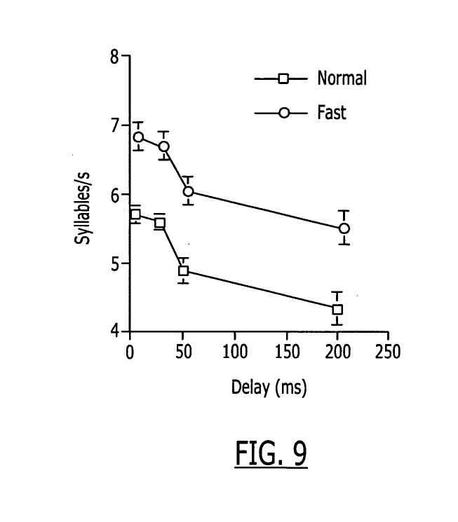

FIG. 9 illustrates that speech rates automatically reduce for non-stutterers responsive to treatment with DAF (delayed auditory feedback) signals having shortened delays of less than about 100 ms. Thus, as shown in FIGS. 7A and 7B, embodiments of the present invention are directed to treating individuals having a disorder known as “cluttering” where their associated natural speech rate is typically well above or abnormally faster than normal speech rates. This abnormal speed or speech rate can reduce their intelligibility. Thus, as shown in FIG. 7B, by selecting the device 10 to generate a DAF signal with a shortened delay (block 110) and delivering to an individual having the cluttering syndrome a DAF signal having a suitable short delay (block 112) can automatically cause the individual to slow or reduce their speech rate to a more normal speech rate (block 113). FIG. 7A schematically illustrates the influence of such a treatment, with the speech rate over time without such input greater than the speech rate over time with DAF treatment. The shortened DAF delay amount can be selected to be less than or equal to about 100 ms. In other embodiments, the delay can be set to less than or equal to about 50 ms. For example, between about 10-50 ms. This delay can be adjusted periodically by re-programming the desired delay amount via a programmable interface (100, FIG. 5), as will be discussed further below.

As described above, the device 10 can be minimally obtrusive with components that are portable. As such, certain embodiments do not require remotely located wired and/or stationary components for normal use. The present invention now provides for portable and non-intrusive device that allows for day-to-day use or “chronic” use.

In certain embodiments, at least the microphone 24, the A/D converter 76, the attenuator, and the receiver 70 can be incorporated into a digital signal processor (DSP) microprocessing chip 90, such as that available from Micro-DSP Technology Co., Ltd., located in Chengdu, Sichuan, People's Republic of China, a subsidiary of International Audiology Centre Of Canada Inc. Embodiments of the DSP will be discussed further below. This chip may be particularly suitable for use in devices directed to users desiring minimally obtrusive devices that do not interfere with normal life functions. Beneficially, allowing day-to-day use may improve fluency, intelligibility and/or normalcy in speech. Further, the compact device permits on-going day to day or at-will (“on-demand”) periodic use may improve communication skills and/or clinical efficacy of the therapy and feedback.

In order to provide on-going or chronic therapy, the device can be worn for a desired block of time, i.e., for a desired number of hours per day of use or per treatment day, and for a minimum number of treatment days within a treatment period (such as weekly, bimonthly, monthly or yearly). Thus, the device can be worn 1, 2, 3, 4, or 5 hours or more each treatment day and for majority of days within each treatment period. In certain embodiments, the device can worn for a number of consecutive treatment days during each treatment period; for example, 3, 4, or 5 (e.g., consecutive days) days within a weekly treatment period, for 1, 2, or 3 or more consecutive weekly treatment periods. Further, the device 10 can be effectively used in one, or both, ears as noted above.

Thus, the present invention now provides for portable and substantially non-intrusive device that allows for periodic day-to-day use or “chronic” use. As such, the portable device 10 can be allowed for on-going use without dedicated remote loose support hardware, i.e., the device can be configured with the microphone positioned proximate the ear. That is, the present invention provides a readily accessible reading or speaking assist instrument that, much like optical glasses or contacts, can be used at will, such as only during planned or actual reading periods when there is a need for remedial intervention to improve communication skills.

The device can employ digital signal processing (“DSP”). FIG. 5 illustrates a schematic diagram of a circuit employing an exemplary signal processor 90 (DSP) with a software programmable interface 100. The broken line indicates the components can be held in or on the miniaturized device 10E such as, but not limited to, the BTE, ITC, ITE, or CIC device. However, as noted above, in other embodiments certain of these components can be held in the remote wirelessly operated housing 10R. Generally described, the signal processor receives a signal generated by a user's speech; the signal is analyzed and delayed according to predetermined parameters. Finally, the delayed signal is transmitted into the ear canal of the user.

In certain embodiments, as illustrated in FIG. 5, a receiver 70 such as a microphone 12 or transducer 53 receives the sound waves. The transducer 70 produces an analog input signal of sound corresponding to the user's speech. According to the embodiment shown in FIG. 5, the analog input signal is converted to a stream of digital input signals. Prior to conversion to a digital signal, the analog input signal can be filtered by a low pass filter 72 to inhibit aliasing. The cutoff frequency for the low pass filter 72 should be sufficient to reproduce a recognizable voice sample after digitalization. A conventional cutoff frequency for voice is about 8 kHz. Filtering higher frequencies may also remove some unwanted background noise. The output of the low pass filter 72 is input to a sample and hold circuit 74. As is well known in the art, the sampling rate should exceed twice the cutoff frequency of the low pass filter 72 to prevent sampling errors. The sampled signals output by the sample and hold circuit 74 are then input into an Analog-to-Digital (A/D) converter 76. The digital signal stream representing each sample is then fed into a delay circuit 78. The delay circuit 78 could be embodied in multiple ways as is known to one of ordinary skill in the art. For example, the delay circuit 78 can be implemented by a series of registers with appropriate timing input to achieve the delay desired.

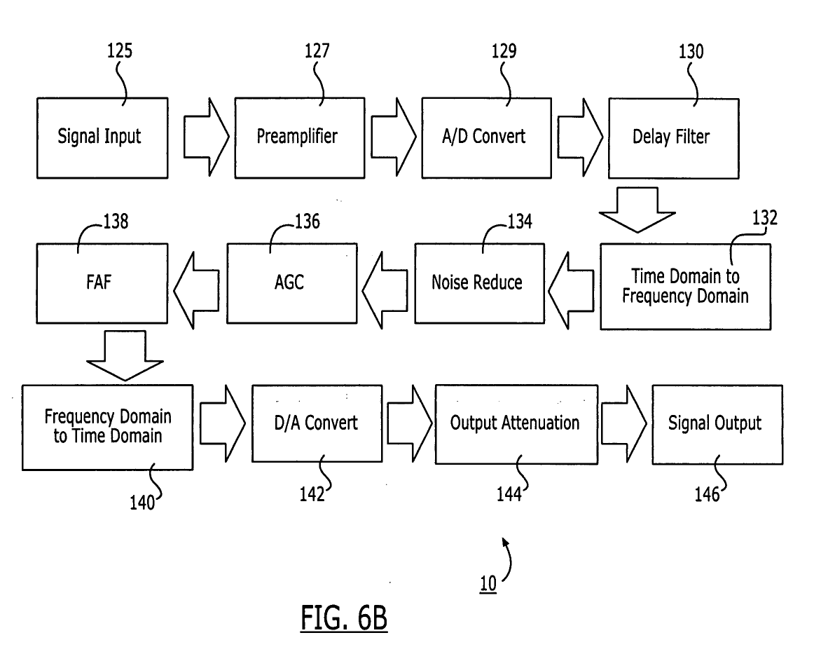

The device 10 can also include circuitry that can provide a frequency altered feedback signal (FAF) as well as the DAF signal as illustrated in FIG. 6B. As before, an input signal is received 125, directed through a preamplifier(s) 127, then through an A/D converter 129, and through a delay filter 130. Where FAF adjustments are desired, the digital signal can be converted from the time domain to the frequency domain 132, passed through a noise reduction circuit 134, and then through compression circuitry such as an AGC 136 or WDRC. The frequency shift is applied to the signal to provide a frequency altered feedback signal (FAF) 138, the FAF signal is reconverted to the time domain 140, passed through a D/A converter 142, and then an output attenuator 144, culminating in output of the DAF and/or DAF and FAF signal 146.

FIG. 6A is a schematic illustration of a known programmable DSP architecture that may be particularly suitable for generating the DAF-based treatments in compact devices. This system is known as the Toccata™ system and is available from Micro-DSP Technology Co., Ltd., a subsidiary of International Audiology Centre Of Canada Inc. The Toccata technology supports a wide-range of low-power audio applications and is the first software programmable chipset made generally available to the hearing aid industry.

Generally described, with reference to FIG. 6A, by incorporating a 16-bit general-purpose DSP(RCore), a Weighted Overlap-Add (WOLA) filterbank coprocessor and a power-saving input/output controller, the Toccata chipset offers a practical alternative to traditional analog circuits or fixed function digital ASICs. Two 14-bit A/D and a 14-bit D/A provide high-fidelity sound. Toccata's™ flexible architecture makes it suitable to implement a variety of algorithms, while meeting the constraints of low power consumption high fidelity and small size. Exemplary features of the Toccata™ DSP technology include: (a) miniaturized size; (b)low-power, about a 1.5 volt or less operation, (c)low noise; (d) 14-bit A/Ds & amp(s); (e) D/A interface to industry-standard microphones; (f) Class D receivers and telecoils; (g) RCore: 16-bit software-programmable Harvard architecture DSP; (h)configurable WOLA filterbank coprocessor efficiently implements analysis filtering, gain application and synthesis filtering; and (i) synthesis filtering.

Exemplary Performance Specifications of the Tocatta™ technology DSP are described in Table 1.

TABLE 1

| Parameter | | |
|---|---|---|
| Operation Voltage | 1.2 | V |
| Current Consumption¹ | 1 | mA |
| Input/Output Sampling Rate | 32 | kHz |
| Frequency Response | 200-7000 | Hz |
| THD + N | <1% | |
| (@ −5 dB re: Digital Full Scale) | | |
| Programmable Analog | 18, 22, 28 | dB |
| Preamplifier Gain | | |
| Programmable Digital Gain | 42 | dB |
| Programmable Analog Output | 12, 18, 24, 30 | dB |
| Attenuation | | |
| Equivalent Input Noise | 24 | dB |

¹may be algorithm dependent

As noted above, in certain embodiments, the device 10 can be configured to also provide a selectable frequency shift. The frequency shift can be any desired shift, typically in the range of ±2 octaves. In particular embodiments, the device can have a frequency altered feedback or “FAF” frequency shift that is at or less than about ±one (1)octave. In other embodiments, the frequency shift can be at about ±⅛, ½ or 1 or multiples thereof or different increments of octave shift.

In certain embodiments, the DAF will include a delay of about 50 ms and may also include a frequency alteration, such as at about plus/minus one-quarter or one-half of an octave.

The frequency shift will be dependent upon the magnitude of the input signal. For example, for a 500 Hz input signal, a one octave shift is 1000 Hz; similarly, a one octave shift of a 1000 Hz input signal is 2000 Hz. In any event, it is preferred that the device be substantially “acoustically invisible” so as to provide the high fidelity of unaided listening and auditory self-monitoring while at the same time delivering optimal altered feedback, e.g., a device which maintains a relatively normal speech pattern.

Referring again to FIG. 5, the output of the delay circuit 78 (and optionally the frequency shift circuit) can be fed into a Digital-to-Analog (D/A) converter 82. The analog signal out of the D/A converter 82 is then passed through a low pass filter 84 to accurately reproduce the original signal. The output of the low pass filter 84 is fed into an adjustable gain amplifier 86 to allow the user to adjust the output volume of the device. Finally the amplified analog signal is connected to a speaker 24. The speaker 24 will then recreate the user's spoken words with a delay.

Optionally, the device 10 may have an automatically adjustable delay operatively associated with the auditory delay circuit. In such an embodiment, the delay circuit can include a detector that detects a number of predetermined triggering events (such as dysfluencies associated with cluttering and the like) within a predetermined time envelope. The delay circuit or wave signal processor can include a voice sample comparator 80 for comparing a series of digitized voices samples input to the delay circuit 78, and output from the delay circuit 78. As is known in the art, digital streams can be compared utilizing a microprocessor. The voice sample comparator 80 can output a regulating signal to the delay circuit to increase or decrease the time delay depending on the desired speech pattern and the number of disfluencies and/or abnormal speech rate detected. For example, the delay can be set to operate at about 50 ms, however, if the comparator 80 detects a speech rate that is above a predefined value(s) or a substantial relative increase in that user's speech, the delay can be automatically adjusted up or down in certain increments or decrements (such as between about 10 ms-50 ms increments or decrements).

The device 10 may also have a switching circuit (not shown) to interrupt transmission from the microphone to the earphone, i.e., an activation and/or deactivation circuit. One example of this type of circuit is disclosed in U.S. Pat. No. 4,464,119 to Vildgrube et al. See, e.g., column 4, lines 40-59. This patent is hereby incorporated by reference in its entirety herein. The device 10 can be configured to be interrupted either by manually switching power off from the batteries, or by automatic switching when the user's speech and corresponding signal input falls below a predetermined threshold level. This can inhibit sounds other than the user's speech from being transmitted by the device.

Alternatively, as is known in the art, other delay circuits can be employed such as, but not limited to, an analog delay circuit like a bucket-brigade circuit.

For each of the circuit components and associated operations described, as is known in the art, other discrete or integrated circuit components can be interchanged with those described above to generate a suitable DAF signal as contemplated by the present invention.

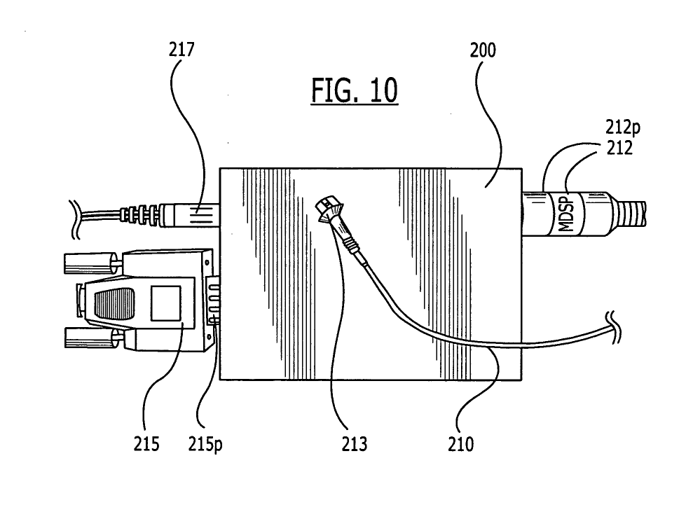

FIG. 10 illustrates an example of a computer interface device 200 that is used to allow communications between a computer (not shown) via a cable 215 extending from a serial (COM) port 215p on the interface device 200 to the compact device 10 via cable 210. The cable 210 is connected to the interface device 200 at port 212p. The other end 213 of the cable 210 is configured to connect to one or more configurations of the compact therapeutic device 10. The interface device 200 also includes a power input 217. One commercially available programming interface instrument is the AudioPRO from Micro-DSP Technology, Ltd., having a serial RS-232C cable that connects to a computer port and a CS44 programming cable that releaseably connects to the FAF treatment device 10 See www.micro-dsp.com/product.htm.

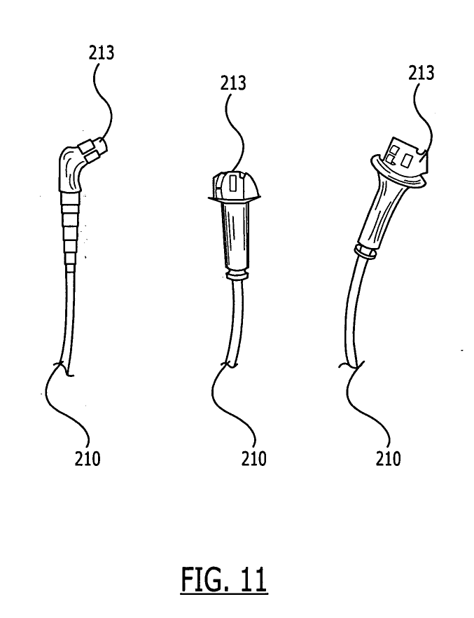

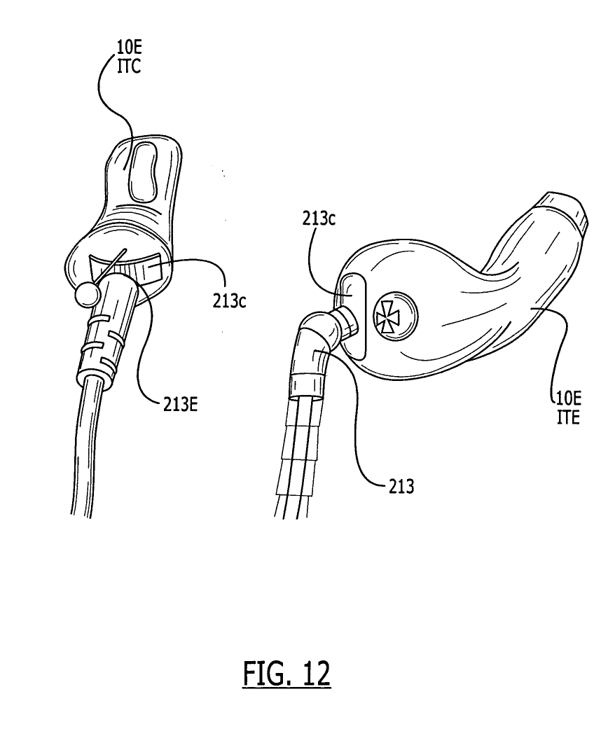

FIG. 11 illustrates an enlarged view of a portion of the cable 210. The first end 213 connects directly into a respective compact therapeutic device 10 as shown in FIG. 12. An access port 10p is used to connect an interface cable 210 to the digital signal processor 90. The port 10p can be accessed by opening an external door 10D (that may be the battery door). The device 10E shown on the left side of the figure is an ITC device while that shown on the right side is an ITE, each has a cable end connection 213c that is modified to connect to the programming cable 210. The ITC device connection 213c includes slender elongated portion to enter into the device core.

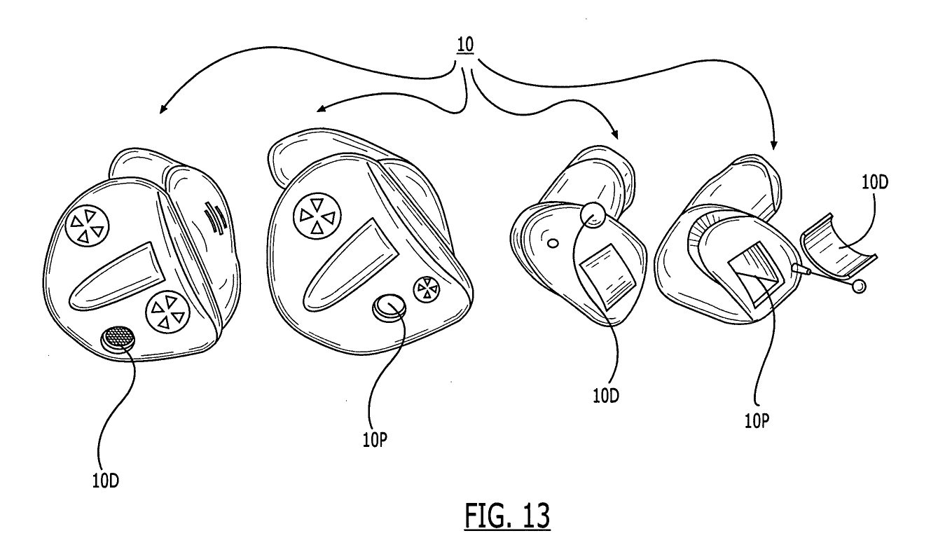

FIG. 13 illustrates two self-contained miniaturized devices 10 (with the ear-mounted unit forming the entire unit during normal use) each is shown both with and without a respective access door 10d in position over the port 10p.

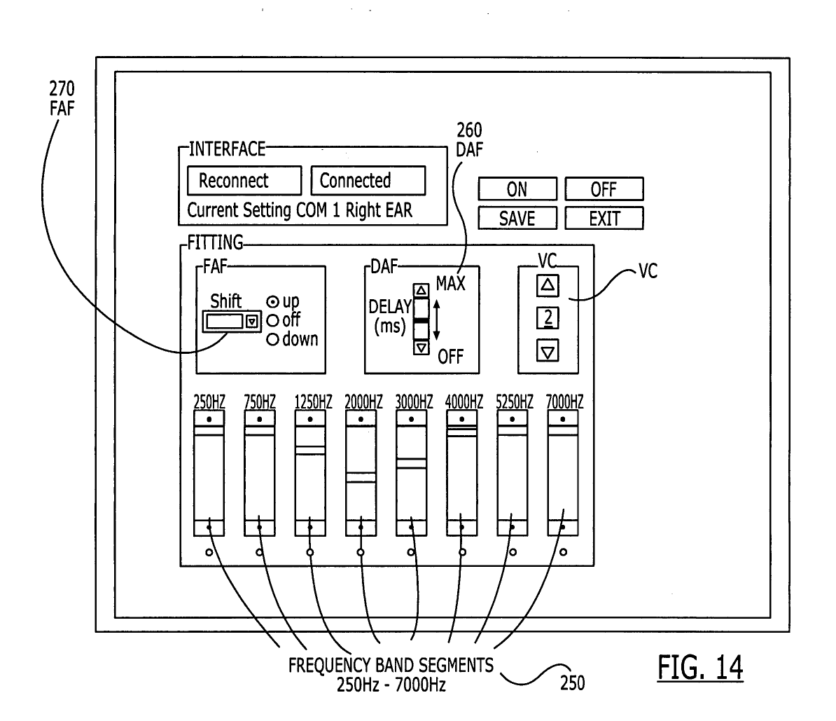

FIG. 14 illustrates a user input interface used to adjust or select the programmable features of the device 10 to fit or customize to a particular user or condition. The overall gain can be adjusted as well as the gain for each “n” band gain control with associated center frequencies 250 (i.e., where n=eight, each of the eight bands can be respectively centered at a corresponding one of 250 Hz, 750 Hz, 1250 Hz, 2000 Hz, 3000 Hz, 4000 Hz, 5250 Hz, 7000 Hz). Typically, n can be between about 2-20 different bands with spaced apart selected center frequencies. For DAF implementations, the delay can be adjusted by user/programmer or clinician set-up selection 260 in millisecond increments and decrements (to a maximum) and can be turned off as well.

The FAF is adjustable via user input 270 by clicking and selecting the frequency desired. The frequency adjustment is adjustable by desired hertz increments and decrements and may be shifted up, down, and turned off.

As will be appreciated by those of skill in the art, the digital signal processor and other electronic components as described above may be provided by hardware, software, or a combination of the above. Thus while the various components have been described as discrete elements, they may in practice be implemented by a microprocessor or microcontroller including input and output ports running software code, by custom or hybrid chips, by discrete components or by a combination of the above. For example, one or more of the A/D converter 76, the delay circuit 78, the voice sample comparator 80, and the gain 86 can be implemented as a programmable digital signal processor device. Of course, the discrete circuit components can also be mounted separately or integrated into a printed circuit board as is known by those of skill in the art. See generally Wayne J. Staab, Digital Hearing Instruments, 38 Hearing Instruments No. 11, pp. 18-26 (1987).

As described above, the altered feedback circuit may be analog or digital or combinations thereof. As is well known to those of skill in the art, an analog device may generally requires less power than a device which includes DSP and as such can be lighter weight and easier to wear than a DSP unit. Also known to those of skill in the art, analog units are generally less suitable for manipulating a frequency shift into the received signal due to non-desirable signal distortions typically introduced therewith. Advantageously, DSP units can be used to introduce one or more of a time delay and a frequency shift into the feedback signal.

In any event, the electroacoustic operating parameters of the device preferably include individually adjustable and controllable power output, gain, and frequency response components. Of course, fixed circuits can also be employed with fixed maximum output, gain, and frequency response while also providing an adjustable volume control for the wearer. In operation, the device will preferably operate with “low” maximum power output, “mild” gain, and a relatively “wide” and “flat” frequency response. More specifically, in terms of the American National Standards Institute Specification of Hearing Aid Characteristics (ANSI S3.22-1996), the device preferably has a peak saturated sound pressure level-90 (“SSPL90”) equal to or below 110 decibels (“dB”) and a high frequency average (HFA) SSPL90 will preferably not exceed 105 dB.

In certain embodiments, a frequency response is preferably at least 200-4000 Hz, and more preferably about 200-8000 Hz. In particular embodiments, the frequency response can be a “flat” in situ response with some compensatory gain between about 1000-4000 Hz. The high frequency average (i.e., 1000, 1600, and 2500) full-on gain is typically between 10-20 dB. For example, the compensatory gain can be about 10-20 dB between 1000-4000 Hz to accommodate for the loss of natural external ear resonance. This natural ear resonance is generally attributable to the occluding in the external auditory meatus and or concha when a CIC, ITE, ITC or ear mold from a BTE device is employed. The total harmonic distortion can be less than 10%, and typically less than about 1%. Maximum saturated sound pressure can be about 105 dB SPL with a high frequency average of 95-100 dB SPL and an equivalent input noise that is less than 35 dB, and typically less than 30 dB.

As described in more detail above, examples of non-stuttering speech and/or language disorders that may be treated by embodiments of the invention include, but are not limited to: Parkinson's disease, autism, aphasis, dysarthria, dyspraxia, language and/or speech disorders such as disorders of speech rate including cluttering. As also described above the DAF treatment methods, devices, and systems may be suitable to treat individuals having learning disabilities and/or reading disorders such as dyslexia, ADD and ADHD to improve cognitive ability, comprehension, and communication skills.

The invention will now be described with reference to the following examples, which are intended to be non-limiting to the invention.

### EXAMPLES

The effect of short and long auditory feedback delays at fast and normal rates of speech with normal speakers is shown in FIGS. 8 and 9. In contrast to previous research a conventional definition of dysfluency, consistent with the operational construct used in the examination of the dysfluency in those that stutter, was adopted. This definition excluded speech errors that are associated with other pathological conditions (i.e., developmental articulation errors).

### Method

Seventeen normal speaking adult males aged 19 to 57 (M=32.9 years, SD=12.5), served as participants. All participants presented with normal middle ear function (American Speech-Language-Hearing Association, 1997) and normal hearing sensitivity defined as having pure-tone thresholds at octave frequencies from 250 to 8000 Hz and speech recognition thresholds of ≦20 dB HL (American National Standards Institute, 1996). All individuals had a negative history of neurological, otological, and psychiatric disorders.

Apparatus and Procedure

All testing was conducted in an audiometric test suite. Participants spoke into a microphone (Shure Prologue Model 12L-LC) which the output was fed to an audio mixer (Mackie Micro Series 1202) and routed to a digital signal processor (Yamaha Model DSP-1) and amplifier (Optimus Model STA-3180) before being returned bilaterally through earphones (EAR Tone Model 3A). The digital signal processor introduced feedback delays of 0, 25, 50, or 200 ms to the participants' speech signal. The shorter delays were identical to those utilized by Kalinowski, Stuart, Sark, and Armson (1996) with persons who stutter. The 200 ms delay was chosen to be representative of a long delay that was employed in numerous previous studies with normal speakers. The output to the earphones was calibrated to approximate real ear average conversation sound pressure levels of speech outputs from normal-hearing participants. All speech samples were recorded with a video camera (JVC Model S-62U) and a stereo videocassette recorder (Samsung Model VR 8705).

Participants read passages of 300 syllables with similar theme and syntactic complexity. Passages were read at both normal and fast speech rates under each DAF condition. Participants were instructed to read with normal vocal intensity. For the fast rate condition, participants were instructed to read as fast as possible while maintaining intelligibility. Speech rates were counterbalanced and DAF conditions were randomized across participants.

The number of dysfluent episodes and speech rates were determined for each experimental condition by trained research assistants. A dysfluent episode was defined as a part-word prolongation, part-word repetition, or inaudible postural fixation (i.e., “silent blocks”; Stuart, Kalinowski, & Rastatter, 1997). The same research assistant recalculated dysfluencies for 10% of the speech samples chosen at random. Intrajudge syllable-by-syllable agreement was 0.92, as indexed by Cohen's kappa (Cohen, 1960). Cohen's kappa values above 0.75 represent excellent agreement beyond chance (Fleiss, 1981). A second research assistant independently determined stuttering frequency for 10% of the speech samples chosen at random. Interjudge syllable by syllable agreement, was 0.89 as indexed by Cohen's kappa. Speech rate was calculated by transferring portions of the audio track recordings onto a personal computer's (Apple Power Macintosh 9600/300) hard drive via the videocassette recorder interfaced with an analog to digital input/output board (Digidesign Model Audiomedia NuBus). Sampling frequency and quantization was 22050 Hz and 16 bit, respectively. Speaking rate was determined from samples of 50 perceptually fluent syllables that were contiguous and separated from dysfluent episodes by at least one syllable. Sample duration represented the time between acoustic onset of the first syllable and the acoustic offset of the last fluent syllable, minus pauses that exceeded 0.1 s. Most pauses were inspiratory gestures with durations of approximately 0.3 to 0.8 s. Speech rate, in syllables/s, was calculated by dividing the number of syllables in the sample by the duration of each fluent speech sample.

### Results

Means and standard deviations for dysfluencies (i.e., number of dysfluent episodes/300 syllables) as a function of DAF and speech rate are shown in FIG. 1. A two-factor analysis of variance with repeated measures was performed to investigate the effect of DAF and speech rate on dysfluencies. Statistically significant main effects of DAF [F (3,48)=8.73, Huynh-Felt p=0.0015, η²=0.35] and speech rate [F(1,16)=5.88, Huynh-Felt p=0.028, η²=0.27] were found. The effect sizes of these significant main effects were large (Cohen, 1988). The interaction of speech rate by DAF was not significant [F (3,48)=1.10 Huynh-Felt p=0.33, η²=0.064, φ=0.20 at α=0.05]. Post hoc orthogonal single-df contrasts showed that while the mean differences in dysfluencies at 0, 25, and 50 ms were not significantly different from each other (p>0.05) they were all significantly less than that at 200 ms (p<0.05).

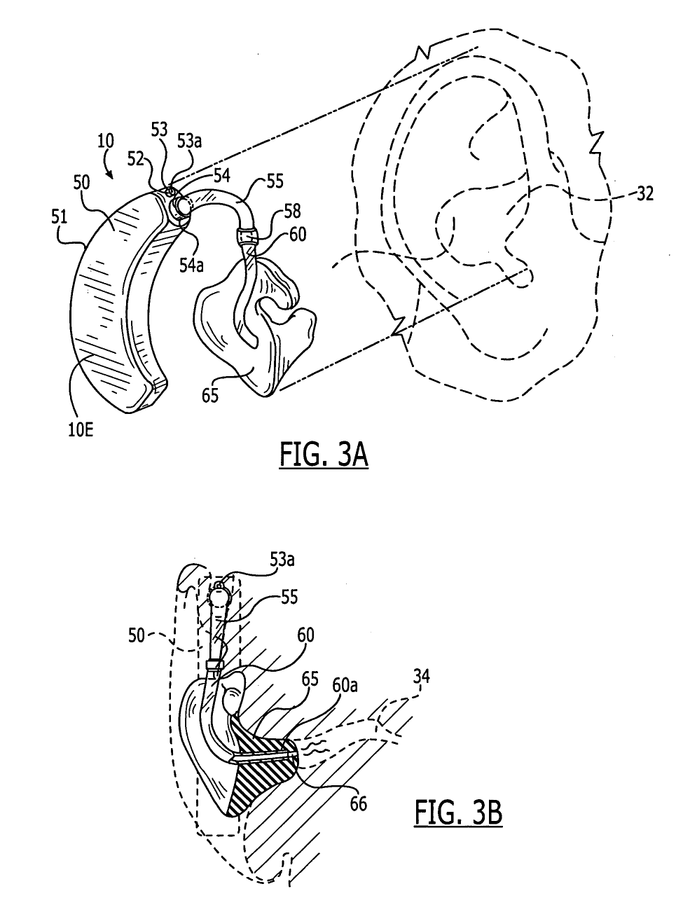

Mean syllable rates and standard deviations as a function of DAF and speech rate are displayed in FIG. 2. A two-factor analysis of variance with repeated measures were performed to investigate the effect of DAF and speaking rate on syllable rate. Statistically significant main effects of DAF [F (3,48)=39.32, Huynh-Felt p<0.0001, η²=0.71] and speaking rate condition [F(1,16)=31.98, Huynh-Felt p<0.0001, η²=0.66] were found. The effect sizes of these significant main effects were large (Cohen, 1988). A nonsignificant DAF by speaking rate condition was found [F (3,48)=0.02, Huynh-Felt p=0.99, η²=0.001, φ=0.054 at α=0.05]. Post-hoc orthogonal single-df comparisons revealed that there was no significant difference between syllable rates at 0 and 25 ms (p>0.05), they were significantly greater than 50 and 200 ms syllable rates and the 50 ms was significantly greater than the 200 ms syllable rate (p<0.05). In other words, participants were able to increase syllable rate when they were asked to speak fast under all DAF conditions. Participants decreased syllable rate at 50 and 200 ms during both speech rates relative to 0 and 25 ms DAF.

### Discussion and Conclusions

The present findings are threefold: first, DAF induced more significantly more dysfluencies only at the longest delay (i.e., 200 ms). In other words, normal speakers were capable of producing fluent or nearly fluent speech with short auditory feedback delays (i.e., ≦50 ms) that were equivalent to speech produced with no delay (i.e., 0 ms). Second, more dysfluencies were evident at a fast rate of speech. This finding would be consistent with increased motor load (Abbs & Cole, 1982; Borden, 1979; Borden & Harris, 1984). Finally, consistent with previous research (Black, 1951, Ham et al., 1984; Lee, 1950; Siegel et al., 1982; Stager & Ludlow, 1993), reduced speech rate was evidenced at auditory feedback delays greater than 25 ms with a greater reduction in syllable rate with an increase in DAF (i.e., 200 relative to 50 ms).

These findings suggest that temporal alterations in auditory feedback signal impact the speech-motor control system differentially for people who stutter and those that do not. That is, at delays of ≧50 ms individuals who stutter experience significant reductions (i.e., approximately 90%) in stuttering frequency (e.g., Kalinowski et al., 1996) while, in contrast, normal speakers begin to experience dysfluent behavior at delays of >50 ms. What remains is a parsimonious explanation for two apparent paradoxical effects in altered auditory feedback.

Models of normal and stuttered speech production/monitoring have generally discounted the role of auditory feedback of having any significant role or any direct impact on central speech production commands since it is too slow (Borden, 1979; Levelt, 1983, 1989). As recognition of running speech is possible only at approximately 200 ms following production (Marslen-Wilson & Tyler, 1981, 1983) one could suggest that it should be of no surprise that the disruption of running speech production does not occur at auditory feedback of delays less than 200 ms in normal speakers. That is, peripheral feedback mechanisms (audition, taction, and/or proprioception) are affecting central speech motor control.

In the past, it was generally posited that the stuttering reducing properties of DAF were due to an altered manner of speaking, specifically syllable prolongation and not to any antecedent in the auditory system (Costello-Ingham, 1993; Perkins, 1979; Wingate, 1976). However, the role of the auditory system and DAF was revised by Kalinowski et al. (1993) who suggested that if a slow speech rate was necessary for stuttering reduction, then the stuttering reducing properties of DAF should not be evident when individuals who stutter speak at a fast speech rate. They had individuals who stutter read passages under conditions of altered auditory feedback including DAF at normal and fast rates of speech. Their results showed that stuttering episodes decreased significantly by approximately 70% under DAF regardless of speaking rate. These findings contradicted the notion regarding the importance of syllable prolongation to fluency induced by DAF. It was not suggested that syllable prolongation is unimportant to stuttering reduction per se, but rather, when syllable prolongation is eliminated, such as when speaking at a fast rate, the stuttering reduction properties of DAF are just as robust and can be most likely attributed to their impact on the auditory system.

Recent findings from brain imaging studies provide some answers regarding how DAF may impact the auditory system of individuals who stutter. Magnetoencephalography (MEG) offers excellent temporal resolution (i.e., ms) in the analysis of cerebral processing in response to auditory stimulation. It has been known for more than a decade that a robust response (M100) generated in supratemporal auditory cortex in response to auditory stimuli beginning 20 to 30 ms and peaking approximately 100 ms after stimulus onset (Näätänen & Picton, 1987). More recently it has been demonstrated that an individual's own utterances can reduce the M100 response. Curio, Neuloh, Numminen, Jousmaki, and Hari (2000) examined such during a speech/replay task. In the speech condition participants uttered two vowels in a series while listening to a random series of two tones. In the replay condition the same participants listened to the recorded vowel utterances from the speech condition. The self-produced recorded vowels evoked the M100 response in the replay condition. More interestingly this response was significantly delayed in both auditory cortices and reduced in amplitude prominently in the left auditory cortex during speech production of the same utterances in the speech condition. Similar findings of inhibition of cortical neurons have been found with primates during phonation (Müller-Preuss, Newman, & Jurgens, 1980; Müller-Preuss & Ploog, 1981). These data have been interpreted to indicate central motor-to-speech priming in the form of inhibition of the auditory cortices during speech production (Curio et al. 2000).

The implications of these findings can lead one to speculate that this motor-to speech priming may be defective in individuals who stutter. There is evidence to suggest that this is the case: Salmelin et al. (1998) reported in another MEG study that the functional organization of the auditory cortex is different in those who stutter relative to normal fluent speakers. MEG was recorded while individuals who stutter and matched controls read silently, read with oral movement but without sound, read aloud, and in chorus with another while listening to tones delivered alternately to the left and right ears. M100 responses were the same in the two silent conditions but delayed and reduced in amplitude during the two spoken conditions. Although the temporal response of the M100 was similar between the two groups response amplitude was not. An unusual interhemispheric balance was evident with the participants who stuttered. The authors reported “rather paradoxically, dysfluency was most likely to occur when the hemispheric balance in stutterers become more like that in normal controls . . . dysfluent vs fluent reading conditions in stutterers were associated with differences specifically in the left auditory cortex . . . [and] source topography also differed in the left hemisphere” (p. 2229). It has been suggested that suppression and/or delay of the M100 response during tasks reflects a diminution in the number or synchrony of auditory cortical neurons available for processing auditory input—in the case speech production and perception (Hari, 1990; Näätänen & Picton, 1987). Salmelin et al. (1998) suggested that the interhemispheric balance is less stable in those who stutter and may be more easily unhinged with an increased work load (i.e., speech production). Disturbances may cause transient unpredictable disruptions in auditory perception (i.e., motor-to-speech priming after Curio et al., 2000) that could initiate stuttering. Salmelin et al. (1998) pointedly remarked, that during choral reading where all participants who stutter were fluent, left hemispheric sensitivity was restored. This may be the case with all fluency-enhancing conditions of altered auditory feedback including DAF. The left auditory cortex as the locus of discrepancy between fluent speakers and those with stuttering has been implicated in numerous other brain imaging studies (e.g., Braun et al., 1997; De Nil, Kroll, Kapur, & Houle, 2000; Fox et al., 2000; Wu et al., 1995). There is also recent converging evidence implicating anomalous anatomy (i.e., planum temporale and posterior superior temporal gyrus) in persons who stutter (Foundas, Bollich, Corey, Hurley, & Heilman, 2001). It remains to be seen if this is a cause or effect of stuttering. Further research is warranted.

Finally, considering the contrast in fluency/dysfluency exhibited between normal speakers and those who stutter and the differences in the functional organization in the brain between individuals who stutter and fluent speakers, it appears that speech disruption of normal speakers under DAF is a poor analog of stuttering. MEG studies have implicated the role of the auditory system on a central level and on a time scale compatible with the behavioral effects of DAF on the overt manifestations of the disorder. The data herein implicate the peripheral feedback system(s) of fluent speakers for the disruptive effects of DAF on normal speech production.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses, where used, are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method for treating a cluttering speech disorder in a subject, wherein the natural speech rate of the subject is abnormally fast relative to the general population, comprising:
administering a delayed auditory feedback signal to the subject having a cluttering speech and/or language disorder, wherein the delayed auditory feedback signal has an associated delay that is less than 200 ms.

2. A method according to claim 1, wherein the delayed auditory feedback signal has an associated delay of about 100 ms or less.

3. A method according to claim 1, wherein the step of administering the delayed auditory feedback signal is carried out by a self-contained compact device, and wherein the delay causes the user to speak at more normal speech rate.

4. A method according to claim 3, wherein the device is configured as a BTE, ITE, ITC, or CIC device.

5. A method according to claim 3, wherein the device is configured for chronic use by the subject.

6. A method for treating non-stuttering speech and/or language disorders in a subject in need of such treatment, comprising:
administering a delayed auditory feedback signal with a delay of less than about 100 ms to the subject.

7. A method according to claim 6, wherein the step of administering is carried out proximate in time to when the subject is performing at least one task of the group consisting of: communicating with another; writing; listening; speaking and/or reading.

8. A method according to claim 6, wherein said step of administering comprises:
(a) positioning a device for receiving auditory signals associated with the subject's speech in close proximity to the ear of the subject, the device being adapted to be in communication with the ear canal of the subject;
(b) receiving an audio signal associated with the subject's speech in the device;
(c) generating the delayed auditory signal so that the signal has the delay of less than about 100 ms responsive to the received audio signal; and
(d) transmitting the delayed auditory signal to the ear canal of the subject.

9. A method according to claim 8, wherein said device is an ear-supported device.

10. A method according to claim 9, wherein said step of generating the delayed auditory signal comprises processing the received signal to provide the delayed auditory feedback in a portable remote housing and wirelessly transmitting the delayed auditory feedback signal to the ear-mounted device, which in turn transmits the signal to the ear canal of the subject.

11. A method according to claim 9, wherein said steps of receiving, generating, and transmitting are carried out by the ear-supported device.

12. A method according to claim 6, wherein the delay is about 50 ms or less, and the subject has Parkinson's disease.

13. A method according to claim 6, further comprising treating a subject having autism.

14. A method according to claim 6, further comprising treating a subject having a reading disorder.

15. A method according to claim 6, further comprising treating a subject having aphasis.

16. A method according to claim 6, further comprising treating a subject having dysarthria.

17. A method according to claim 6, further comprising treating a subject having dyspraxia.

18. A method according to claim 6, further comprising treating a subject having a voice disorder.

19. A method according to claim 6, further comprising treating a subject having a speech rate disorder.

20. A method according to claim 6, wherein the delay of step (c) is below about 50 ms.

21. A device for treating a cluttering speech disorder, wherein the natural speech rate of a subject is abnormally fast relative to the general population, comprising:
means for generating a delayed auditory feedback signal of a subject, wherein the delayed auditory feedback signal has an associated delay that is less than 200 ms; and
means for transmitting the delayed auditory signal to the subject having a cluttering speech and/or language disorder.

22. A device according to claim 21, wherein the delayed auditory feedback signal has an associated delay of about 100 ms or less.

23. A device according to claim 22, wherein the delayed auditory feedback signal has an associated delay of about 50 ms or less.

24. A device for treating non-stuttering speech and/or language disorders, comprising:
means for generating a delayed auditory feedback signal of a subject with a delay of less than about 100 ms; and
means for transmitting the delayed auditory signal to the subject having a non-stuttering speech and/or language disorder.

25. A device according to claim 24, wherein the delayed auditory feedback signal has an associated delay of about 50 ms or less.

26. A device according to claim 25, wherein the means for generating and transmitting the delayed auditory feedback signal comprises a self-contained ear-mounted device.

27. A device according to claim 25, wherein the device is adapted to be worn by a subject having Parkinson's disease.

28. A device according to claim 24, wherein the device is adapted to be worn by a subject having autism.

29. A device according to claim 24, wherein the device is adapted to be worn by a subject having a reading disorder.

30. A device according to claim 24, wherein the device is configured to treat subjects having at least one of aphasis, dysarthria, dyspraxia, voice disorders, and/or disorders of speech rate.

31. A portable device for treating non-stutterers having speech and/or language disorders, the device comprising:
(a) an ear-supported housing having opposing distal and proximal surfaces, wherein at least said proximal surface is configured for positioning in the ear canal of a user;
(b) a signal processor comprising:
(i) a receiver, said receiver generating an input signal responsive to an auditory signal associated with the user's speech;
(ii) delayed auditory feedback circuitry operatively associated with the receiver for generating a delayed auditory signal having a delay of about 100 ms or less; and
(iii) a transmitter operatively associated with said delayed auditory feedback circuitry for transmitting the delayed auditory signal to the user; and
(c) a power source operatively associated with said signal processor for supplying power thereto,
wherein the signal processor is configured to reside in the ear-supported housing and/or in a wirelessly operated portable housing that is configured to be worn by the user that wirelessly communicates with the ear-supported housing to cooperate with the ear-supported housing to deliver the delayed auditory feedback to the user.

32. A device according to claim 31, wherein said signal processor is mounted in the ear-supported housing, and wherein the housing is configured as an ITE device.

33. A device according to claim 31, wherein said signal processor is mounted in the ear-supported housing, and wherein the ear-supported housing is an ITC device.

34. A device according to claim 31, wherein said signal processor is mounted in the ear-supported housing, and wherein the ear-supported housing is a CIC device.

35. A device according to claim 31, wherein said signal processor is mounted in the ear-supported housing, and wherein said ear-supported housing is a BTE device.

36. A device according to claim 31, wherein said signal processor is a digital programmable signal processor having programmably adjustable delays.

37. A device according to claim 36, wherein said receiver is a microphone, and wherein said microphone is integrated in the digital signal processor.

38. A device according to claim 31, wherein said delayed auditory feedback circuitry provides a delay of 50 ms or less.

39. A device according to claim 38, wherein the device is adapted to be worn by a user having Parkinson's disease.

40. A device according to claim 31, wherein the device is adapted to be worn by a user having autism.

41. A device according to claim 31, wherein the device is adapted to be worn by a user having a reading disorder.

42. A device according to claim 31, wherein the device is configured to treat users having at least one of aphasis, dysarthria, dyspraxia, voice disorders, and/or disorders of speech rate.

43. A device according to claim 31, wherein the device is configured to treat users having speech rate disorders.
